(19) United States
(12) Patent Application Publication
(10) Pub. No.: US 2012/0069020 A1
(43) Pub. Date: Mar. 22, 2012

(54) Lighting Control for Occlusion-based Volume Illumination of Medical Data

(75) Inventor: Mervin Mencias Smith-Casem, Renton, WA (US)

(73) Assignee: SIEMENS MEDICAL SOLUTIONS USA, INC., Malvern, PA (US)

(21) Appl. No.: 12/887,393

(22) Filed: Sep. 21, 2010

(51) Int. Cl. G06T 15/50

(52) U.S. Cl. 345/426

(57) ABSTRACT

Occlusion-based lighting control is provided in volume rendering of medical data. In addition to altering the brightness of a sample based on the degree of occlusion, the opacity for the sample is also or alternatively altered. For direct volume rendering, the depth of samples along a given ray contributing to the rendered pixel may be limited due to saturation. By varying the opacity, the depth at which samples contribute may be increased for less occluded samples.

### BACKGROUND

The present embodiments relate to volume rendering of medical data. In particular, lighting control for occlusion-based volume illumination is provided.

Shading may enhance rendering of medical data. The effects of light on a rendering are modeled. One approach to shading uses surface gradients. A surface-based lighting model approximates surface normal vectors using estimates of local gradients. The angle between the gradient and the light source determines, at least in part, the amount of lighting in the rendered image for that location. However, gradient-based techniques may perform sub-optimally with ultrasound data. In ultrasound data, speckle and other noise sources cause variation throughout a volume. The variation may cause the local gradient estimates to vary significantly, even with lowpass-filtered ultrasound data and gradient magnitudes.

Another approach to shading is occlusion-based illumination models. These models do not use gradient-based illumination. The extinction of light from other samples in the volume between the light source(s) and the sample to be lighted or shaded is modeled. A parameter that represents the amount of occlusion (e.g., shadowing) is computed for each sample, and this parameter is used to adjust the brightness or dimness of the sample.

### BRIEF SUMMARY

By way of introduction, the preferred embodiments described below include a method, system, instructions, and computer readable media for lighting control in occlusion-based volume illumination in volume rendering of medical data. In addition to altering the brightness of a sample based on the degree of occlusion, the opacity for the sample is also or alternatively altered. For projection or direct volume rendering, the depth of samples along a given ray contributing to the rendered pixel may be limited due to saturation of the accumulated opacity. Typically, compositing can be accelerated by stopping the compositing operation when the accumulated opacity reaches a sufficiently high value, such as 95% of maximum. This technique may be referred to as early ray termination. By varying the opacity, the depth at which samples contribute may be increased for less occluded samples. Saturation of the accumulated opacity occurs at a deeper location and allows more opportunity for colors to saturate and brighten the pixel. Adjusting the opacity is different than adjusting the color because of the non-linear nature of the alpha-blending-based compositing operation.

In a first aspect, a method is provided for lighting control in occlusion-based volume illumination of medical data. Ultrasound data representing a volume of a patient are acquired. A degree of light occlusion is determined for each of a plurality of locations represented by the ultrasound data. A color of the ultrasound data is set for each of the locations as a function of the respective degree of light occlusion. An opacity of the ultrasound data is set for each of the locations as a function of the respective degree of light occlusion. An image of the volume is rendered with the ultrasound data. The rendering is a function of the color and the opacity.

In a second aspect, a system is provided for lighting control in occlusion-based volume illumination of medical data. An ultrasound imaging system is configured to scan an internal volume of a patient with a transducer. A processor is configured to apply a volume illumination model that characterizes a degree to which light is occluded at a position in the internal volume and to adjust an opacity for a sample of ultrasound data representing the position. The adjustment of the opacity is a function of the degree to which the light is occluded. A display is operable to generate an image of a three-dimensional rendering. The image is a function of the opacity adjusted as the function of the degree to which the light is occluded.

In a third aspect, a non-transitory computer readable storage medium has stored therein data representing instructions executable by a programmed processor for lighting control in occlusion-based volume illumination of medical data. The storage medium includes instructions for varying opacities for different locations based on respective amounts of occlusion for the different locations, the varying corresponding to relatively less opacity for relatively lower of the amounts of occlusion and relatively greater opacity for relatively higher of the amounts of occlusion, and rendering an image as a function of the opacities as varied based on the amounts of occlusion.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is flow chart diagram of one embodiment of a method for lighting control in occlusion-based volume illumination of medical data;

FIG. 2 is an example rendering of a fetal face without opacity control based on occlusion;

FIG. 3 is an example rendering of a fetal face with opacity control based on occlusion; and

FIG. 4 is a block diagram of one embodiment of an ultrasound system for lighting control in occlusion-based volume illumination of medical data.

### DETAILED DESCRIPTION OF THE DRAWINGS AND PRESENTLY PREFERRED EMBODIMENTS

For occlusion-based volume illumination modeling, the color and opacity of samples computed during the compositing operation of the volume rendering pipeline are adjusted. The color is darkened in more occluded areas and brightened or maintained in less occluded areas. The opacity is reduced in less occluded areas and increased or maintained in more occluded areas. Brightness of lighted areas and the darkness of shaded areas are controlled for volume rendering with both color and opacity change. In the compositing calculations, color is used. The brightness is a characteristic of the particular color values. The change in color may result in and/or be accomplished by a change in brightness. Similarly, a change in brightness may result in and/or be accomplished by a change in color.

Dark and bright are opposites, but brightening may be performed by the inverse darkening and vice versa. Where the level of brightness is used, the level is also one of darkness. Opaque and transparent are opposites, so setting opacity may be performed by the inverse setting of transparence and vice versa. Where the level of opacity is used, the level is also one of transparency.

In one embodiment, a gradient-free illumination model, which may be better-suited to lighting noisy data (e.g., ultrasound data), is used. The volume illumination model characterizes the degree to which light is occluded at a given position in space. A sample's color brightness is adjusted such that the change in brightness is proportional to the degree to which light is unimpeded (not occluded) at the sample's position. The color may be adjusted by altering a scalar value prior to color mapping or by altering color mapped values (e.g., red, green, blue (RGB) values). A sample's opacity is adjusted such that the change in opacity is proportional (e.g., inversely proportional) to the degree to which light is occluded at the sample's position.

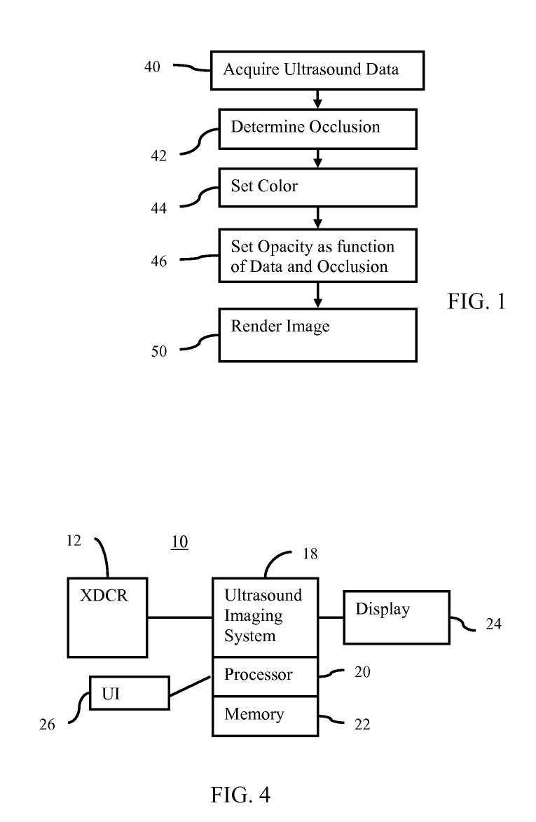

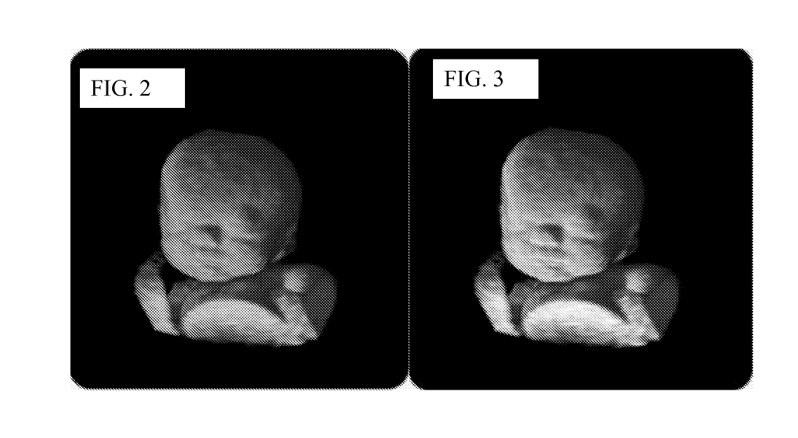

FIG. 1 shows a method for lighting control in occlusion-based volume illumination of medical data. The acts of FIG. 1 are implemented by the system 10 of FIG. 4 or a different system. The acts shown in FIG. 1 are performed in the order shown or a different order. Additional, different, or fewer acts may be performed. For example, act 44 may not be used. The acts are described below in the context of ultrasound data, but other types of medical data may be used.

The lighting control is part of an occlusion-based model. The degree of occlusion is used to set the brightness of samples contributing to a given pixel in rendering. The opacity is alternatively or additionally set as a function of the degree of occlusion. Determining the degree of occlusion, setting the brightness, and setting the opacity are performed for controlling lighting in the rendering.

The lighting control is performed for each sample contributing to the rendered image. The determination of the degree of occlusion, setting the brightness, setting the opacity, and compositing is performed separately for each of the locations in the volume. Locations along each ray are composited together, at least until the saturation of the accumulated opacity, using the brightness and opacity. The samples at each location are separately processed for degree of occlusion, setting brightness, and setting opacity. The separate process may use data from the process for adjacent locations, such as adding to and/or subtracting from a value for one location to shift a window to an adjacent location. Samples for the entire volume contributing to the rendered image are processed. The processing occurs regardless of whether or not any or what anatomy is represented. The anatomy may cause a given sample and/or opacity to be different, but edges or other anatomy structure is not located or identified in order to apply the lighting.

In act 40, ultrasound data representing a volume of a patient is acquired. Acoustic energy echoes from the tissue or fluid and is received by a transducer. The resulting ultrasound data represents the acoustic echoes from the patient. The scanning may be for B-mode, color flow mode, tissue harmonic mode, contrast agent mode or other now known or later developed ultrasound imaging modes. Combinations of modes may be used, such as scanning for B-mode and Doppler mode data. Any ultrasound scan format may be used, such as a linear, sector, or Vector®. Using beamforming or other processes, data representing the scanned region is acquired. The data is in an acquisition format (e.g., Polar coordinate system) or interpolated to another format, such as a regular three-dimensional grid (e.g., Cartesian coordinate system). Different ultrasound values represent different locations within the volume.

Any type of scanning may be used, such as planar or volume scanning. For planar scanning, multiple planes are sequentially scanned. The transducer array may be rocked, rotated, translated or otherwise moved to scan the different planes from the same acoustic window or multiple acoustic windows. The volume is scanned by electronic, mechanical, or both electronic and mechanical scanning. The resulting data represents a volume.

The same region may be scanned multiple times from the same acoustic window. The resulting data is combined, such as by persistence filtering, a more optimal one of the resulting data sets is selected, or an on-going or real-time sequence of rendered images is generated from the multiple scans.

In one embodiment, the scanning is from different acoustic windows. Any two or more different acoustic windows or transducer locations may be used so that an extended volume (larger than possible by one array at one acoustic window) is acquired. The transducer is sequentially positioned at different windows. Alternatively, multiple transducers are used to allow either sequential or simultaneous scanning from different windows.

In another embodiment, the ultrasound data is acquired by data transfer or from storage. For example, ultrasound data from a previously performed ultrasound examination is acquired from a picture archival or other data repository. As another example, ultrasound data from an on-going examination or previous examination is transferred over a network from one location to another location, such as from an ultrasound imaging system to a workstation in the same or different facility. In yet another alternative embodiment, the medical data is from x-ray, magnetic resonance, computed tomography, positron emission, or other medical scanning technique.

In act 42, a degree of light occlusion is determined. The determination is made for each of a plurality of locations represented by the ultrasound data. The degree of occlusion is determined for each location based on one or more adjacent locations. For example, rays cast from a lighting source are virtually positioned in the volume. The degree of light occlusion between the sample and the light source is computed. The degree of occlusion along the ray to a given location is determined. The degree of occlusion for one location may be determined from a degree of occlusion for another location along the same ray. Each location has a separate degree, whether the same or not, as another location along the same ray. As another example, the degree of occlusion is determined from local samples. A one, two, or three dimensional window is positioned around each given location to determine the degree of occlusion for that location from the surrounding neighborhood. There may be more than one light source or light direction if evaluating occlusion from the ambient light.

The degree of occlusion is a parameter. The parameter is calculated for each location. Any function may be used for calculating occlusion. For example, the opacity of samples is averaged or otherwise used to determine a degree of occlusion. The function used varies with the occlusion-based lighting model. For example, the function for computing the occlusion parameter is based on the volume rendering integral. The volume rendering integral is evaluated from the sample to a single light source along a ray segment of programmable length. Using a single light source reduces the computation overhead since computing the occlusion from multiple light sources (or light directions) increases the computation time. Multiple light sources and directions may be used. The occlusion parameter is based on the accumulated opacity along the ray segment. Other functions may be used.

In act 44, a color or brightness of the ultrasound data is set. The brightness is set by adjusting a color. The color may be adjusted directly, such as changing an RGB value. For example, the red, green, and blue values are adjusted equally or unequally. The color may be adjusted indirectly, such as changing the ultrasound data prior to color mapping. For example, B-mode scalar values are adjusted. In other embodiments, the brightness is set by inclusion of a value of a variable in originally calculating a sample. Selecting a color map or other functions may be used to set the brightness. Calculating a weight for addition, multiplication, division, or other mathematical relationship with the sample may be used.

The color is set for each of the locations. Since the base sample value for a given location may be different, the color for each sample may be different. Since the degree of occlusion for each sample may be different, the color for each sample after adjustment may be different. The color may be the same or different for different locations. Color brightness is varied as a function of the opacities for occlusion-based shadowing throughout an entire volume.

The color is set as a function of the degree of light occlusion. The degree of light occlusion for a given location is used to set the brightness for that given location. The brightness may be increased, decreased, or maintained the same. The color parameters of each sample may be brightened or darkened. For example, locations associated with a higher value for the degree of occlusion are darkened by reducing the color level (e.g., 172 scalar value in a range of 0-255 reduced to 142). Locations associated with a lower value for the degree of occlusion are brightened (e.g., increasing the color level) or maintained (e.g., 123 scalar value in a range of 0-255 increased to 133). The maximum brightening, corresponding to the minimum occlusion, may be clamped or set as merely maintaining a sample value. Alternatively, the sample value may be increased. Similarly, the minimum brightening (maximum darkening), corresponding to the maximum occlusion, may be clamped to a given maximum change or left the same. Any linear, non-linear, or other function may be used to map the adjustment to the degree of occlusion.

A shadowing strength parameter, s, may be used with the occlusion factor. The shadowing strength parameter is user set or may be preprogrammed. In other embodiments, the parameter is adaptive, such as to an average of the samples in a region or entire volume.

In one embodiment, the color, such as a red-green-blue triplet is adjusted using the corresponding occlusion factor, k, at each sample position. The color_{adjusted}=color*scale_{color}, where scale_{color}=k*(1−s)+s. The color, k, and s may be mapped to any range, such as all being within 0-1. Alternatively, k and s are within 0-1 and the color is a value within a greater range, such as 0-255. Other functions may be used, such as where the scale_{color} is added to, subtracted, or divides from the color value. For example, the scale_{color} may be equal to k, or k in some other function with the same or different variables. The degree to which color is adjusted may be limited. For example, scale_{color} is limited or clamped at a maximum or minimum value once a level of adjustment is reached.

In act 46, an opacity of the ultrasound data is set. The opacity is set by calculating an opacity from one or more variables, such as determining an opacity from an equation using the sample of the ultrasound data and degree of light occlusion. Alternatively, the opacity is set by adjusting a previously determined opacity. For example, an opacity is assigned as part of rendering. The opacity is assigned based on the ultrasound data, such as providing higher opacity for higher values of the ultrasound data. Any mapping function may be used. The opacity is then set for lighting by scaling or otherwise altering. Any function, such as multiplication, division, addition, or subtraction, may be used to scale or adjust the opacity. The function relates the degree of occlusion to an amount of opacity.

The opacity is set for each of the locations. Since the base opacity value for a given location may be different or the same, the opacity for each sample may be different or the same. Since the degree of occlusion for each sample may be different, the opacity for each sample after adjustment may be different. The opacity may be the same or different for different locations. Opacity is varied as a function of the degree of light occlusion for occlusion-based shadowing throughout an entire volume, or at least for samples contributing to a rendered image.

The opacity is set as a function of the degree of light occlusion. The degree of light occlusion for a given location is used to set the opacity for that given location. Opacities for different locations are varied based on respective amounts of occlusion for the different locations. The opacity may be increased, decreased, or maintained the same. For example, opacity is reduced for a lesser degree of occlusion and is increased or maintained (e.g., no change or a 1.0 multiplication weight) for a higher degree of occlusion. The variation corresponds to relatively less opacity for relatively lower of the amounts of occlusion and relatively greater opacity for relatively higher of the amounts of occlusion. The maximum or minimum opacity level and/or adjustment of opacity may be clamped or set. Any linear, non-linear, or other function may be used to map the adjustment to the degree of occlusion.

In one embodiment, the opacity is adjusted using the corresponding occlusion factor, k, at each sample position. The shadowing strength parameter, s, may or may not also be used for adjusting the opacity. For example, the opacity_{adjusted}=opacity*scale_{opacity}, where scale_{opacity}=(1−k)*(1−s)+s. The opacity, k, and s may be mapped to any range, such as all being within 0-1. Alternatively, k and s are within 0-1 and the opacity is a value within a greater range, such as 0-63 or 0-255. Other functions may be used, such as where the scale_{opacity} is added to, subtracted, or divides from the color value. For example, the scale_{opacity} may be equal to k, or k in some other function with the same or different variables. The degree to which opacity is adjusted may be limited. For example, scale_{opacity} is limited or clamped at a maximum or minimum value once a level of adjustment is reached. As another example, the opacity is clamped to a maximum or minimum value.

In act 50, an image is generated from the ultrasound data. One or more images are generated from the ultrasound dataset. The image is rendered from the ultrasound data representing the volume. The image is a rendering of the volume. Any type of rendering may be used, such as volume rendering, surface rendering, or other three-dimensional imaging.

In one embodiment, projection or direct rendering is provided. The projection rendering casts rays through the volume for each pixel in the image. Data along each ray is used to determine the pixel intensity and/or color. Any compositing or projection function may be used, such as averaging, alpha blending, combination, or selection of information (e.g., maximum value selection) from along the viewing direction.

Opacity (e.g., 1-transparency level) is used as part of the rendering. Opacity may be used to differentiate between sections of the volume data for rendering the anatomy of the patient. The opacity is used to emphasize the data for some locations relative to other locations, such as emphasizing locations with stronger echoes (e.g., greater ultrasound values). The opacity is assigned such that greater opacity is provided for greater values of the ultrasound data and lesser opacity is provided for lesser values of the ultrasound data. Any mapping function may be used. For example, a binary function assigns a high opacity to data above a threshold and a low opacity for data below the threshold. Other functions may be used, such as a curve or linear mapping function.

During compositing, the adjusted opacity and the adjusted ultrasound data are used. The ultrasound data is a color or scalar value, such as the value adjusted for brightness. The ultrasound data is weighted by the opacity. The opacity weighted ultrasound data along the ray line is composited. The compositing may include interpolation from adjacent samples where the ray line is not aligned to the volume or 3D grid.

The image includes rendering with a light, whether a single point or directed light source, multiple point or directed light sources, or ambient light. The light appears to penetrate at least part of the tissue. The shading emulates the effects of lighting the volume data by employing surface-based (e.g., gradient-based) illumination or by employing occlusion-based illumination. The light source or sources may be positioned at a different or same angle relative to the volume than the viewer. The lighting is emulated by the adjustment of the brightness of the values used in the rendering. The adjustment of act 44 provides shadowing. These lighting queues indicate depth or relative positioning in three-dimensions. Any now known or later developed shading operation may be used in the rendering.

The depth along each ray line through the volume may be limited. For example, the compositing occurs until a given pixel or composite value reaches a limit, such as the saturation of the accumulated opacity. The accumulated opacity along a ray line may reach a maximum value. Once the maximum accumulated opacity value is reached, the compositing along that ray line is stopped. Ultrasound values and the opacity at deeper depths are not used for the compositing. Starting from a front and proceeding towards a back of the volume from the viewer's direction, the depth at which ultrasound data along a ray line contributes to each pixel may be limited due to saturation of the accumulated opacity.

By adjusting the opacity as a function of the degree of light occlusion, the depth along the ray lines before saturation of the accumulated opacity may be increased. The depth or locations at which saturation of the accumulated opacity occurs are a function of the varying of the opacities. Decreasing the opacity increases the depth of the contribution along one or more of the ray lines, such as along ray lines with at least some locations associated with a lesser degree of occlusion. The lesser degree of occlusion is used to adjust the opacity to a lesser value. The lesser opacity results in the corresponding ultrasound value contributing less to the composite value, making saturation of the accumulated opacity, if any, occur at a deeper depth along the ray line or making saturation of the accumulated opacity less likely to occur. The opacity adjustment allows colors in less occluded areas to brighten more easily than colors in more occluded areas by allowing the compositing operation to progress further into the volume and saturate bright colors.

FIGS. 2 and 3 show the effect of varying the opacity as a function of the degree of occlusion. These figures are rendered using alpha blending in projection rendering with occlusion-based illumination from the same data set. The degree of occlusion is computed for a ray segment from a lighting source (e.g., local occlusion with a single light source) rather than computing occlusion along an entire ray line from a lighting source. The scaling functions using k and s discussed above were used. FIG. 2 shows an image rendered with color (e.g., brightness) and not opacity being adjusted as a function of the degree of occlusion. FIG. 3 shows an image rendered with both the color and opacity adjusted as a function of the degree of occlusion. Less-shadowed areas in FIG. 3 appear brighter.

FIG. 4 shows a system 10 for lighting control in occlusion-based volume illumination of medical data. The system 10 includes a transducer 12, an ultrasound imaging system 18, a processor 20, a memory 22, a display 24, and a user interface 26. Additional, different, or fewer components may be provided. For example, the system 10 does not include the user interface 26. In one embodiment, the system 10 is a medical diagnostic ultrasound imaging system. In other embodiments, the processor 20 and/or memory 22 are part of a workstation or computer different or separate from the ultrasound imaging system 18. The workstation is adjacent to or remote from the ultrasound imaging system 18.

The transducer 12 is a single element transducer, a linear array, a curved linear array, a phased array, a 1.5 dimensional array, a two-dimensional array, a radial array, an annular array, a multidimensional array, a wobbler, or other now known or later developed array of elements. The elements are piezoelectric or capacitive materials or structures. In one embodiment, the transducer 12 is adapted for use external to the patient, such as including a hand held housing or a housing for mounting to an external structure. More than one array may be provided, such as a support arm for positioning two or more (e.g., four) wobbler transducers adjacent to a patient (e.g., adjacent an abdomen of a pregnant female). The wobblers mechanically and electrically scan and are synchronized to scan the entire fetus and form a composite volume. In other embodiments, a single hand-held transducer is provided for scanning different planes while being moved or for scanning a volume from one or more acoustic windows. In alternative embodiments, the transducer 12 is adapted for use within the patient, such as being on a transesophegeal or cardiac catheter probe.

The transducer 12 converts between electrical signals and acoustic energy for scanning a region of the patient body. The region of the body scanned is a function of the type of transducer array and position of the transducer 12 relative to the patient. For example, a linear transducer array may scan a rectangular or square, planar region of the body. As another example, a curved linear array may scan a pie shaped region of the body. Scans conforming to other geometrical regions or shapes within the body may be used, such as Vector® scans. The scans are of a two-dimensional plane. Different planes may be scanned by moving the transducer 12, such as by rotation, rocking, and/or translation. A volume is scanned. The volume is scanned by electronic steering alone (e.g., volume scan with a two-dimensional array), or mechanical and electrical steering (e.g., a wobbler array or movement of an array for planar scanning to scan different planes).

The ultrasound imaging system 18 is a medical diagnostic ultrasound system. For example, the ultrasound imaging system 18 includes a transmit beamformer, a receive beamformer, a detector (e.g., B-mode and/or Doppler), a scan converter, and the display 24 or a different display. The ultrasound imaging system 18 connects with the transducer 12, such as through a releasable connector. Transmit signals are generated and provided to the transducer 12. Responsive electrical signals are received from the transducer 12 and processed by the ultrasound imaging system 18.

The ultrasound imaging system 18 causes a scan of an internal region of a patient with the transducer 12 and generates data representing the region as a function of the scanning. The scanned region is adjacent to the transducer 12. For example, the transducer 12 is placed against an abdomen or within a patient. The ultrasound data is beamformer channel data, beamformed data, detected data, scan converted data, and/or image data. The data represents anatomy of the region, such as the interior of a fetus and other anatomy.

In another embodiment, the ultrasound imaging system 18 is a workstation or computer for processing ultrasound data. Ultrasound data is acquired using an imaging system connected with the transducer 12 or using an integrated transducer 12 and imaging system. The data at any level of processing (e.g., radio frequency data (e.g., I/Q data), beamformed data, detected data, and/or scan converted data) is output or stored. For example, the data is output to a data archival system or output on a network to an adjacent or remote workstation. The ultrasound imaging system 18 processes the data further for analysis, diagnosis, and/or display. In an alternative embodiment, the system 18 is an x-ray, CT, MRI, PET or other medical imaging system. The data is medical scan data other than ultrasound data.

The user input 22 is a button, slider, knob, keyboard, mouse, trackball, touch screen, touch pad, combinations thereof, or other now known or later developed user input devices. The user may operate the user input 22 to interact with the ultrasound imaging system 18 or the processor 20. For example, the use indicates a viewing direction and/or other rendering parameters. As another example, the user selects a value for a shadowing parameter. The user may control the amount of shadowing, illumination, or rendering brightness by setting the shadowing parameter. The user input 22 receives the user settings.

The processor 20 is one or more general processors, digital signal processors, application specific integrated circuits, field programmable gate arrays, controllers, analog circuits, digital circuits, server, graphics processing units, graphics processors, combinations thereof, network, or other logic devices for segmenting and rendering. A single device is used, but parallel or sequential distributed processing may be used. The processor 20 is part of the imaging system 18 or may be separate, such as in a separate computer or workstation local to or spaced from the imaging system 18.

The processor 20 is configured by software to render. The processor implements the determination, setting, and rendering acts 42, 44, 46, and 50 discussed above or different acts. For example, the processor 20 determines the degree of occlusion for various locations, adjusts the ultrasound data, color, and/or opacities accordingly, and renders from the color and opacities.

The processor 20 applies a volume illumination model. The volume illumination model is an occlusion model in one embodiment. The model characterizes a degree to which light is occluded at each of the positions in the internal volume. For each location represented by data or sampled in the scan, the degree of occlusion is determined. For example, the degree to which light is occluded is based on ultrasound data representing adjacent positions (e.g., local occlusion). As another example, occlusion, local or not, along a line from a light source is calculated. The degree of occlusion is determined for each of the positions within an entire scan volume or an entire volume for which data is contributing to the rendered image. The entire volume is a volume of the patient and includes data for volume positions in a regular 3D grid, in an anisotropic grid, in an acquisition format or other distribution.

The processor 20 adjusts a color brightness of the sample of the ultrasound data representing each of the positions. The adjustment of the color brightness is a function of the degree to which the light is occluded. Any adjustment may be made, such as any now known or later developed adjustment for occlusion-based illumination in rendering.

The processor 20 adjusts the opacity separately from the adjustment of color brightness. The opacity is adjusted for each of a plurality of volume positions. The adjustment of the opacity is a function of the degree to which the light is occluded. Any adjustment may be made, such as scaling the opacity by multiplying by a weight. The opacity is adjusted using a function relating the degree to which the light is occluded to an amount of opacity adjustment. For example, the opacity is reduced for a lesser degree and is increased or maintained for a higher degree. Inverse adjustment may be used in other embodiments.

The processor 20 may adjust the brightness and/or the opacity as a function of user input. The user indicates a level of illumination, such as setting a value of a shadowing parameter. The scaling or adjustments applied by the processor 20 may include the shadowing parameter. Separate adjustment of the data for the shadowing parameter may be used, such as multiplying the opacity and/or data value by two weights—one for degree of occlusion and another for the shadowing parameter.

The processor 20 is configured to render the image from the medical data. Any type of rendering may be provided, such as surface rendering or volume rendering (e.g., projection rendering). Compositing is performed along a plurality of ray lines. The compositing for each ray line continues until saturation of the accumulated opacity or the end of the volume. The depth of the data along each of the ray lines contributing to the compositing is a function of the opacity. For example, adjusting of the opacity increases the depth of the contribution along at least one of the ray lines.

The memory 22 is a tape, magnetic, optical, hard drive, RAM, buffer or other memory. The memory 22 stores the medical data from one or more scans, at different stages of processing, and/or as a rendered image.

The memory 22 is additionally or alternatively a computer readable storage medium with processing instructions. Data representing instructions executable by the programmed processor 20 is provided for lighting control in occlusion-based volume illumination of medical data. The instructions for implementing the processes, methods and/or techniques discussed herein are provided on non-transitory computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The display 24 is a CRT, LCD, projector, plasma, printer, or other display for displaying two-dimensional images or three-dimensional representations or renderings. The display 24 generates an image of the three-dimensional rendering, such as shown in FIG. 3. The image data is provided to the display 24. The display 24 displays the rendered image from the provided image data. The image represents a view from viewer's perspective of the internal volume of the patient. Data from different locations is represented in the image. The color brightness reflects the scan data, opacity, and illumination. The image is a function of the opacity adjusted as the function of the degree to which the light is occluded. The image on the display 24 is output from volume or surface rendering.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method for lighting control in occlusion-based volume illumination of medical data, the method comprising:
acquiring ultrasound data representing a volume of a patient;
determining a degree of light occlusion for each of a plurality of locations represented by the ultrasound data;
setting a color of the ultrasound data for each of the locations as a function of the respective degree of light occlusion;
setting an opacity of the ultrasound data for each of the locations as a function of the respective degree of light occlusion; and
rendering an image of the volume with the ultrasound data, the rendering being as a function of the color and the opacity.

2. The method of claim 1 wherein determining the degree of light occlusion comprises determining the degree for each of the locations based on adjacent locations, and wherein setting the color comprises adjusting a color or the ultrasound data for each of the locations corresponding to darkening in for a higher value of the degree of occlusion and brightening or maintaining for a lower value of the degree of occlusion.

3. The method of claim 1 wherein the determining, setting the color, setting the opacity, and rendering is performed separately for each of the locations, the plurality of locations representing an entirety of the acquired volume of the patient.

4. The method of claim 1 wherein the determining, setting the color, setting the opacity, and rendering is performed for each of the locations regardless of any anatomy of the patient represented by the ultrasound data.

5. The method of claim 1 wherein setting the opacity comprises adjusting a previously determined opacity.

6. The method of claim 1 wherein setting the opacity comprises setting with a function relating the degree of occlusion to an amount of opacity where the opacity is reduced for a lesser degree of occlusion and is increased or maintained for a higher degree of occlusion.

7. The method of claim 1 wherein rendering comprises compositing along a plurality of ray lines until saturation of the accumulated opacity, a depth along each of the ray lines contributing to the compositing being a function of the opacity, and wherein the setting of the opacity increases the depth of the contribution along at least one of the ray lines.

8. The method of claim 1 wherein setting the opacity comprises scaling the opacity, the scaling being a function of a parameter set by a user.

9. The method of claim 1 wherein rendering comprises assigning a data opacity based on the ultrasound data, wherein setting the opacity comprises adjusting the data opacity as a function of the degree of occlusion, wherein rendering further comprises compositing along ray lines through the volume, the compositing being a function of the ultrasound data and the opacity.

10. The method of claim 1 wherein determining the degree of occlusion and setting the color and opacity comprise controlling lighting in the rendering.

11. A system for lighting control in occlusion-based volume illumination of medical data, the system comprising:
a transducer;
an ultrasound imaging system configured to scan an internal volume of a patient with the transducer;
a processor configured to apply a volume illumination model that characterizes a degree to which light is occluded at a position in the internal volume, and to adjust an opacity for a sample of ultrasound data representing the position, the adjustment of the opacity being a function of the degree to which the light is occluded; and
a display operable to generate an image of a three-dimensional rendering, the image being a function of the opacity adjusted as the function of the degree to which the light is occluded.

12. The system of claim 11 wherein the processor is configured to adjust a color brightness of the sample of the ultrasound data representing the position, the adjustment of the color brightness being a function of the degree to which the light is occluded, and wherein the image is rendered from the sample as a function of the color brightness.

13. The system of claim 11 wherein the processor is configured to characterize the degree to which light is occluded based on ultrasound data representing adjacent positions to the position.

14. The system of claim 11 wherein the processor is configure to characterize the degree and to adjust the opacity separately for each of a plurality of volume positions, including the position, the plurality of volume positions representing an entirety of the acquired volume of the patient.

15. The system of claim 11 wherein the processor is configured to adjust the opacity with a function relating the degree to which the light is occluded to an amount of opacity adjustment where the opacity is reduced for a lesser degree and is increased or maintained for a higher degree.

16. The system of claim 11 wherein the processor is configured to render the image with compositing along a plurality of ray lines until saturation of an accumulated opacity, a depth along each of the ray lines contributing to the compositing being a function of the opacity, and wherein the adjusting of the opacity increases the depth of the contribution along at least one of the ray lines.

17. The system of claim 11 further comprising:
a user input configured to receive a setting of a shadowing parameter by the user, wherein the processor is configured to adjust the opacity by scaling the opacity, the scaling being a function of the setting of the shadowing parameter.

18. In a non-transitory computer readable storage medium having stored therein data representing instructions executable by a programmed processor for lighting control in occlusion-based volume illumination of medical data, the storage medium comprising instructions for:
varying opacities for different locations based on respective amounts of occlusion for the different locations, the varying corresponding to relatively less opacity for relatively lower of the amounts of occlusion and relatively greater opacity for relatively higher of the amounts of occlusion; and
rendering an image as a function of the opacities as varied based on the amounts of occlusion.

19. The non-transitory computer readable storage medium of claim 18 further comprising varying color brightness as a function of the opacities for occlusion-based shadowing throughout an entire volume, the rendering being of the image representing the entire volume where depths along ray lines deeper than points at which saturation of an accumulated opacity occurs are not composited, the points at which saturation of an accumulated opacity occurs being a function of the varying of the opacities.

20. The non-transitory computer readable storage medium of claim 18 wherein the relatively less opacity comprises reducing opacity and wherein the relatively greater opacity comprises increasing or maintaining opacity.
